(19) United States
(12) Patent Application Publication
(10) Pub. No.: US 2015/0236516 A1
(43) Pub. Date: Aug. 20, 2015

(54) WIRELESS POWER TRANSFER SYSTEM

(71) Applicant: DSM IP ASSETS B.V., Heerlen (NL)

(72) Inventors: Robert Hendrik Catharina Janssen, Echt (NL); Roelof Marissen, Echt (NL); Johannes Petrus Marinus Plug, Echt (NL); Harm Van Der Werff, Echt (NL)

(73) Assignee: DSM IP ASSETS B.V., Heerlen (NL)

(21) Appl. No.: 14/425,208

(22) PCT Filed: Oct. 10, 2013
(86) PCT No.: PCT/EP2013/071162

§ 371 Date: Mar. 2, 2015

(30) Foreign Application Priority Data
Oct. 11, 2012 (EP) 12188197.3

(51) Int. Cl. H02J 5/00; F28F 21/06

(52) U.S. Cl. CPC H02J 5/005; F28F 21/06

(57) ABSTRACT

The invention relates to a wireless power transfer system comprising: (a) a receiving magnetic resonator in an electronic device, for receiving electromagnetic energy capable of inducing a current in said receiving magnetic resonator; (b) at least one transmitting magnetic resonator coupled to a power generator, for transmitting the electromagnetic energy; and (c) a heat dissipating device, wherein said heat dissipating device contains a polyolefin fiber.

The invention relates to a wireless power transfer system comprising: (a) at least one receiving magnetic resonator in an electronic device, for receiving electromagnetic energy capable of inducing a current in said receiving magnetic resonator; (b) at least one transmitting magnetic resonator coupled to a power generator, for transmitting the electromagnetic energy; and (c) at least one heat dissipating device.

Wireless power transfer systems have in the last decades became ubiquitous for powering portable or mobile devices for use in e.g. commercial, business, personal, consumer, and other applications. Examples of such devices include cellular telephones, personal digital assistants (PDAs), notebook computers, mobile email devices, Blackberry devices, Bluetooth headsets, hearing aids, music players (for example, MP3 players), radios, compact disk players, video game consoles, digital cameras, walkie-talkie or other communication devices, GPS devices, laptop computers, electric shavers, and electric toothbrushes. Wireless power transfer systems used to power or charge the above mentioned devices typically contain a transmitting magnetic resonator, usually a winding or a coil, and the electronics to drive thereof at an appropriate operating frequency; and a receiving magnetic resonator, e.g. also a winding or a coil, where power is received and then rectified to obtain a required DC voltage. If the two resonators are brought into physical proximity to each other, power is transferred inductively, i.e. by induction, from the transmitter to the receiver, without any physical electrical connection. For instance, document US2012/0146545A1 and WO2012/047550A1 disclose wireless power systems made of a transmitting coil assembly and a receiving coil assembly. Such coils may comprise polyethylene as insulating medium, which is commonly known in the art.

However, a common problem with the wireless power transfer systems known in the art is that especially the transmitting magnetic resonator can reach a high temperature during operation which in turn may damage the device or even become a health hazard. The temperature rise is typically larger for situations where large power transfer is required. Thus the design of devices for wireless transfer of high power becomes progressively difficult.

To prevent the increase of temperature, the device may be set to operate at a lower power; however, this may impair its functionality.

The object of the present invention may thus be to provide a wireless power transfer system which is less affected by the above mentioned disadvantages. The invention therefore provides a wireless power transfer system comprising at least one heat dissipating device, wherein said heat dissipating device contains a polyolefin fiber.

It was observed that the system of the invention may operate at increased powers without reaching dangerously high temperatures. It was further observed that the power at which the system of the invention operates may be increased above the normal limits of known wireless power transfer systems and/or said system of the invention may operate longer at normal or increased levels of power.

The system of the invention contains at least one heat dissipating device, which is a device that dissipates heat and which may be in contact, particularly in thermal contact with the transmitting magnetic resonator and/or with the receiving resonator. Preferably, one heat dissipating device may be in thermal contact simultaneously with the transmitting magnetic resonator and the receiving resonator. More preferably, the transmitting resonator is in thermal contact with one heat dissipating device and the receiving resonator is in contact with a second heat dissipating device. By heat dissipating device is herein understood a device which is able to capture and dissipate the heat generated by said resonator. By thermal contact is herein understood that heat can be transferred between said resonator and said device. It is not necessary that said device is in physical contact with said resonator, as an optimal heat transfer can be achieved through a thermally conductive medium such as for example a commercially available thermally conductive glue or a medium such as the one disclosed in WO 2008/043540, included herein by reference. Air can also be considered a thermally conductive medium however less preferred. Preferably, said device is in physical contact with said resonator, more preferably, said device is in thermal contact with said resonator through a thermally conductive medium, preferably a medium comprising a plastic composition containing a conductive filler. Suitable examples of plastic compositions are disclosed in WO 2008/043540. It was observed that the heat dissipating device used in accordance with the invention also possesses good electrical insulating properties.

The present invention further relates to at least one heat dissipating device comprising a polyolefin fiber, wherein the polyolefin fiber is a ultrahigh molecular weight polyolefin (UHMWPO) fiber, preferably a polyethylene fiber, more preferably a high (HMWPE) or ultrahigh (UHMWPE) molecular weight polyethylene fiber. Ultrahigh molecular weight polyolefin may be a polyolefin, such as polyethylene or polypropylene or an ethylene and/or propylene copolymer having a weight average molecular weight of between 20,000 and 8,000,000 g/mol, preferably between 500,000 and 2,000,000 g/mol.

Preferably, said heat dissipating device contains a body comprising a plurality of polyolefin fibers.

Said body can have any shape known in the art. Suitable examples of shapes of said body include round, such as circle or oval and non-round, such as rectangular; a cup shape and a cone shape, such that the devices related to transmitter and receiver can be positioned one inside the other and/or or mixtures of such shapes in one said body. The body can be for instance a flat, round or non-round body, such as a panel. Preferably, said body is a panel. Said body can also have any dimensions, for instance any length, width, thickness. The size of the body may typically depend on the size of the wireless power transfer system and on the power to be transferred. For instance, the size of the body can be up to 10 times greater than the size of the largest resonator. Suitable practical examples of the body dimensions include a length and a width in a range of between 1 mm to 25 m, preferably 5 mm to 20 m, more preferably 10 mm to 15 m, even more preferably between 50 mm to 5 m and between 100 mm to 1 m and between 50 mm to 0.5 m. The length and the width can also be the longitudinal and respectively the transversal diameter for a round shape. The thickness may for example be between 0.1 mm and 20 mm, preferably between 0.5 mm and 10 mm, more preferably between 0.5 and 5 mm. Preferably, the length and the width are the same. The body may contain a matrix or a binder material which can be utilized to stabilize said fibers inside the body, e.g. to prevent shifting of the fibers and provide handleability to the body. In a preferred embodiment, said body does not contain a binder and/or a matrix material. Such matrix and binder materials are known to the skilled person in the art. Said body can be a flexible body or a rigid body, with the latter being most preferred; and can have a two (2D) or three dimensional (3D) shape. By a rigid body is herein understood a body having a flexural strength of at least 10 MPa, more preferably of at least 20 MPa, most preferably of at least 40 MPa. In a preferred embodiment, the rigid body has a flexural modulus of at least 5 GPa, more preferably at least 20 GPa, most preferably at least 40 GPa. Flexural strength and modulus may be measured according to ASTM D790-07; to adapt for various thicknesses of the body, measurements are performed according to paragraph 7.3 of ASTM D790-07 by adopting a loading and a support nose radius which are twice the thickness of the article and a span-to-depth ratio of 32. A rigid body can be obtained by compressing under pressure and temperature a plurality of fibers in the presence or absence of a matrix material. Such compression processes are well known in the art. Another method which is suitable to make the body is resin transfer molding process (RTM). The RTM process is a well-known process in composites industry and it is also known as vacuum injection. This is typically a process where a liquid resin is injected through a fibrous stack of fabrics followed by a curing process for solidifying the liquid resin.

The polyolefin fiber that may be contained by the body according to the invention may be arranged in a random order, e.g. forming a felt, or they may be arranged in layers containing fibers with a plurality of layers forming said panel. A body comprising a plurality of layers containing fibers is herein referred for simplicity as a multilayer body.

Preferably the body according to the invention is a multilayer body. More preferably, the body is a multilayer panel. The individual layers preferably contain a fabric comprising the polyolefin fibers, wherein said fabric can be a woven or a non-woven fabric. Examples of non-woven fabrics include felts, braids and unidirectional fabrics, i.e. well-known fabrics wherein the fibers are arranged in a substantially parallel fashion.

As matrix or binder, a wide variety of thermosetting or thermoplastic materials can be used. Suitable thermosetting and thermoplastic polymer matrix materials are enumerated in, for example, WO 91/12136 Al (pages 15-21) included herein by reference. From the group of thermosetting polymers, vinyl esters, unsaturated polyesters, epoxides or phenol resins are preferred. From the group of thermoplastic polymers, polyurethanes, polyvinyls, polyacrylics, polyolefins or thermoplastic elastomeric block copolymers such as polyisopropene-polyethylene-butylene-polystyrene or polystyrene-polyisoprene-polystyrene block copolymers are preferred.

By fiber is herein understood at least one elongated body having a length much greater that its transverse dimensions, e.g. a diameter, a width and/or a thickness. The term fiber also includes various embodiments e.g. a filament, a ribbon, a strip, a band, a tape, a film and the like. A fiber may also have a regular cross-section, e.g. oval, circular, rectangular, square, parallelogram; or an irregular cross-section, e.g. lobed, C-shaped, U-shaped. The fibers may have continuous lengths, known in the art as filaments, or discontinuous lengths, known in the art as staple fibers. Staple fibers may be commonly obtained by cutting or stretch-breaking filaments. A yarn for the purpose of the invention is an elongated body containing many fibers.

Preferably, the heat dissipating device according to the present invention comprises a plurality of ultrahigh molecular weight polyolefin fibers.

In a special embodiment of the present invention, the polyolefin fiber is a polyolefin tape, i.e. the fiber has a tape-like shape. It is preferred, however not mandatory, that the tapes used in accordance with the invention are non-fibrous tapes, i.e. tapes obtained with a process different than a process comprising a step of producing fibers and a step of using, e.g. fusing, the fibers to make a tape. A suitable tape for the purposes of the present invention may be a tape having a cross sectional aspect ratio, i.e. the ratio of width to thickness, of preferably at least 5:1, more preferably at least 20:1, even more preferably at least 100:1 and yet even more preferably at least 1000:1. The width of the tape is preferably between 1 mm and 600 mm, more preferable between 10 mm and 400 mm, even more preferably between 30 mm and 300 mm, yet even more preferably between 50 mm and 200 mm and most preferably between 70 mm and 150 mm. The tape preferably has a thickness of between 1 μm and 200 μm and more preferably of between 5 μm and 100 μm. In a preferred embodiment, the tape is produced by a solid-state process, i.e. a process comprising the steps of compressing a polyolefin powder to form a tape-like shaped precursor article and rolling and/or stretching (drawing) said article to form the tape, for instance as disclosed in EP1627719, included herein by reference Such solid-state processes are widely known in the art.

Good results may be obtained when the polyolefin fiber is an ultrahigh molecular weight polyolefin (UHMWPO) fiber. Even better results may obtained when the polyolefin fiber is a polyethylene fiber, more a preferably high (HMWPE) or ultrahigh (UHMWPE) molecular weight polyethylene fiber. The polyethylene fibers may be manufactured by any technique known in the art, preferably by a melt or a gel spinning process. Most preferred the polyolefin fiber is a gel spun UHMWPE fiber, e.g. the fiber sold by DSM Dyneema, NL under the name Dyneema®. If a melt spinning process is used, the polyethylene starting material used for manufacturing thereof preferably has a weight-average molecular weight between 20,000 and 600,000 g/mol, more preferably between 60,000 and 200,000 g/mol. An example of a melt spinning process is disclosed in EP 1,350,868 incorporated herein by reference. If the gel spinning process is used to manufacture said fiber, preferably an UHMWPE is used with an intrinsic viscosity (IV) of preferably at least 3 dl/g, more preferably at least 4 dl/g, most preferably at least 5 dl/g. Preferably the IV is at most 40 dl/g, more preferably at most 25 dl/g, more preferably at most 15 dl/g. IV for polyolefins and in particular for polyethylene is determined according to ASTM D-1601, at 135° C. in decalin, the dissolution time being 16 hours, with DBPC as anti-oxidant in an amount of 2 g/l solution, by extrapolating the viscosity as measured at different concentrations to zero concentration. Preferably, the UHMWPE has less than 1 side chain per 100 C atoms, more preferably less than 1 side chain per 300 C atoms. Side chains in a polyethylene or UHMWPE sample is determined by FTIR on a 2 mm thick compression molded film by quantifying the absorption at 1375 cm⁻¹ using a calibration curve based on NMR measurements (as in e.g. EP 0 269 151). Preferably the UHMWPE fiber is manufactured according to a gel spinning process as described in numerous publications, including EP 0205960 A, EP 0213208 A1, U.S. Pat. No. 4,413,110, GB 2042414 A, GB-A-2051667, EP 0200547 B1, EP 0472114 B1, WO 01/73173 Al, EP 1,699,954 and in “Advanced Fibre Spinning Technology”, Ed. T. Nakajima, Woodhead Publ. Ltd (1994), ISBN 185573 182 7. To produce fibers having a tape-like shape, the above-cited processes may be routinely adapted by using spinning dyes having spinning slits instead of spinning holes.

In a preferred embodiment, the wireless power transfer system of the invention is a wireless charging system, a wireless power socket and plug, a wireless connector or a power station for wireless power transmitters and receivers and more preferably a wireless charging system. The invention therefore also relates to a device comprising said wireless charging system, wireless power socket, wireless power plug, wireless connector or power station for a wireless power transmitter and receiver.

The present invention also relates to a product containing the wireless power transfer system according to the present invention, wherein the product is chosen from the group of products comprising cellular telephones, personal digital assistants (PDAs), notebook computers, mobile email devices, Bluetooth™ headsets, hearing aids, music players (for example, MP3 players), radios, compact disk players, video game consoles, digital cameras, walkie-talkie or other communication devices, GPS devices, laptop computers, electrical vehicles, such as cars and busses, electric shavers and electric toothbrushes. The invention is especially preferred for situations where large power has to be transmitted or where light weight or small sizes are desired. Preferably the invention is applied for devices where the power transfer exceeds 100 Watt, more preferably exceeds 500 Watt and even more preferably when the power transfer exceeds 3000 Watt.

The present invention also relates to the use of a polyolefin fiber for heat dissipation, wherein the polyolefin fiber is a ultrahigh molecular weight polyolefin (UHMWPO) fiber, preferably a polyethylene fiber, more preferably a high (HMWPE) or ultrahigh (UHMWPE) molecular weight polyethylene fiber.

It is noted that the invention relates to all possible combinations of features recited in the claims. Features described in the description may further be combined.

It is further noted that the term ‘comprising’ does not exclude the presence of other elements. However, it is also to be understood that a description on a product comprising certain components also discloses a product consisting of these components. Similarly, it is also to be understood that a description on a process comprising certain steps also discloses a process consisting of these steps.

The invention will be further elucidated with the following examples without being limited hereto.

### EXAMPLES

From a commercially available wireless charger device (Powermat® PMM-HO100) the front original cover was removed so that the power transmitting coil and its magnet became exposed. This original cover was then replaced by a different cover made from various types of plastic materials, as described below. The dimensions of the replacement cover were 100 mm×100 mm×1 mm (length×width×thickness).

The following plastic materials were used for making the plastic covers:
Acrylonitrile butadiene styrene (ABS);
Polycarbonate (PC);
100 wt % ultrahigh molecular weight polyethylene tape known as Dyneema® BT10 from DSM Dyneema;
A hybrid fabric consisting of a mixture of ultrahigh molecular weight polyethylene fibers known as Dyneema® SK 75 from DSM Dyneema® and carbon fibers. The fabric contains a 1:2 in volume ratio blend of Dyneema® SK 75 fibers and carbon fibers.

The materials used to make the covers are all commercially available.

The covers made from ABS and PC are also commercially available. Such covers are typically made by injection moulding at about 20° C. higher temperatures than the melting temperature of the polymer (ABS or PC).

The cover comprising 100 wt % Dyneema was made by compression molding of Dyneema® BT10 tape material at a temperature of 140° C. and a pressure of 100 bar for 30 minutes.

The covers made from ABS and PC are also cut from commercially available sheets.

Such covers are typically made by injection moulding at about 20° C. higher temperatures than the melting temperature of the polymer (ABS or PC).

The cover comprising 100 wt % Dyneema was made by compression molding of Dyneema® BT10 tape cross ply material at a temperature of 140° C. and a pressure of 100 bar for 30 minutes.

The cover comprising the Dyneema® SK75 fiber/Carbon fiber (1:2) hybrid composite fabric was made by applying a resin transfer molding process. A stack of hybrid fabrics (Dyneema® SK75 fiber/Carbon fiber (1:2)) was impregnated with a liquid Daron® resin at room temperature while care was taken for minimalizing the presence of air bubbles (voids), using a vacuum technique. The stack was interleaved between two polyamid films in order to avoid spill of the resin and to maintain the applied vacuum during resin injection. The stack was afterwards pressed at a pressure of 2 bar and the temperature was increased to 100° C. until the resin was completely solidified. The sample was removed from the press after curing. The polyamid cover films were removed, thus revealing the hybrid composite specimen that was cut to size (100 mm×100 mm×1 mm).

A direct current (DC) power sources was connected to the coil. Both a thermal image camera and a thermocouple attached to the upper side of the plate directly above the center of the coil were used to record the temperatures on the top of the plate. It was ascertained that the temperatures recorded by the thermocouple and camera were identical. A DC current of 5 A was used to drive the coil at 6.25 W dissipated power. After power is switched on, the coil started to transmit power through the plastic cover. Depending on the heat dissipating capacity of the material used, the plastic cover started to heat up. The thermal image camera and the thermocouple registered the increase in temperature from the plastic cover in time. After 10 minutes the experiments were stopped.

The results in Table 1 clearly demonstrate higher dissipating capacity with time of the cover material containing UHMWPE compared to other materials.

TABLE 1

| Sample | Temperature, ° C. | | | | |
|---|---|---|---|---|---|
| ABS | 26° C. | 49° C. | 69° C. | 85° C. | 100° C. |
| PC | 26° C. | 52° C. | 73° C. | 88° C. | >100° C. |
| Dyneema ® BT10 | 26° C. | 37° C. | 43° C. | 48° C. | 52° C. |
| Dyneema ® SK 75/ | 26° C. | 39° C. | 50° C. | 58° C. | 64° C. |
| C fiber composite (1:2) | | | | | |
| Time [s] | 0 | 50 | 100 | 150 | 200 |

1. A wireless power transfer system comprising:
a. at least one receiving magnetic resonator in an electronic device, for receiving electromagnetic energy capable of inducing a current in said receiving magnetic resonator;
b. at least one transmitting magnetic resonator coupled to a power generator, for transmitting the electromagnetic energy; and
c. at least one heat dissipating device,
wherein said heat dissipating device contains a polyolefin fiber.

2. The system of claim 1, wherein the polyolefin fiber is a polyolefin tape.

3. The system of claim 1 wherein the polyolefin fiber is an ultrahigh molecular weight polyolefin (UHMWPO) fiber.

4. The system of claim 1, wherein the polyolefin fiber is polyethylene fiber, more preferably high (HMWPE) or ultrahigh (UHMWPE) molecular weight polyethylene fiber.

5. The system of claim 1, wherein the heat dissipating device contains a body comprising a plurality of polyolefin fibers.

6. The system of claim 1, wherein the body contains a matrix and/or a binder material for stabilizing said fibers.

7. The system of claim 1, wherein the body does not contain a binder and/or a matrix material.

8. The system of claim 1 wherein the body is a flexible body or a rigid body.

9. The system of claim 5, wherein the body is a panel.

10. The system of claim 1 wherein the body has a flexural strength of at least 10 MPa measured according to ASTM D790-07.

11. The system of claim 5, wherein the body has a flexural modulus of at least 5 GPa measured according to ASTM D790-07.

12. The system of claim 1 wherein said system is a wireless charging system, a wireless power socket, a wireless power plug, a wireless connector, a power station for a wireless power transmitter and receiver.

13. A product containing the system of claim 1 wherein the product is chosen from the group of products comprising cellular telephones, personal digital assistants (PDAs), notebook computers, mobile email devices, Bluetooth™ headsets, hearing aids, music players, radios, compact disk players, video game consoles, digital cameras, walkie-talkie, GPS devices, laptop computers, electrical vehicles, electric shavers and electric toothbrushes.

14. A heat dissipating device comprising a polyolefin fiber, wherein the polyolefin fiber is a ultrahigh molecular weight polyolefin (UHMWPO) fiber, preferably a polyethylene fiber, more preferably a high (HMWPE) or ultrahigh (UHMWPE) molecular weight polyethylene fiber.

15. Use of a polyolefin fiber for heat dissipation, wherein the polyolefin fiber is a ultrahigh molecular weight polyolefin (UHMWPO) fiber, preferably a polyethylene fiber, more preferably a high (HMWPE) or ultrahigh (UHMWPE) molecular weight polyethylene fiber.
